(19) United States
(12) Patent Application Publication
(10) Pub. No.: US 2013/0038984 A1
(43) Pub. Date: Feb. 14, 2013

(54) COMPOSITION FOR ELECTRODE ACTIVE MATERIAL SLURRY AND ELECTROCHEMICAL CAPACITOR INCLUDING ELECTRODE USING THE SAME

(71) Applicants: Hak Kwan KIM, Seoul (KR); Jun Hee Bae, Seoul (KR); Bae Kyun Kim, Gyeonggi-do (KR); Ho Jin Yun, Gyeonggi-do (KR)

(72) Inventors: Hak Kwan KIM, Seoul (KR); Jun Hee Bae, Seoul (KR); Bae Kyun Kim, Gyeonggi-do (KR); Ho Jin Yun, Gyeonggi-do (KR)

(73) Assignee: Samsung Electro-Mechanics Co., Ltd, Suwon (KR)

(21) Appl. No.: 13/567,661

(22) Filed: Aug. 6, 2012

(30) Foreign Application Priority Data
Aug. 12, 2011 (KR) 10-2011-0080762

(51) Int. Cl. H01G 9/042; H01G 9/058

(52) U.S. Cl. 361/502; 252/182.1

(57) ABSTRACT

A composition for an electrode active material slurry and an electrochemical capacitor including an electrode using the same. The electrochemical capacitor includes: an electrode having a current collector coated with the composition for an electrode active material slurry including an electrode active material, a material including a nonpolar hydrophobic functional group, and a surfactant; a separator; and an organic electrolyte. Additives improving flowability of the electrode active material slurry and wettability to the electrolyte, thereby increase an effective electrode area contacted with the electrolyte and decrease inner resistance of the electrode, with the result that there can be provided an electrochemical capacitor having higher capacitance and lower electrode resistance when the active material and conductive material are added in the same amount.

### CROSS REFERENCE(S) TO RELATED APPLICATIONS

This application claims the benefit under 35 U.S.C. Section 119 of Korean Patent Application Serial No. 10-2011-0080762, entitled “Composition for Electrode Active Material Slurry and Electrochemical Capacitor Including Electrode Using the Same” filed on Aug. 12, 2011, which is hereby incorporated by reference in its entirety into this application.

### BACKGROUND OF THE INVENTION

1. Technical Field

The present invention relates to a composition for an electrode active material slurry and an electrochemical capacitor including an electrode using the same.

2. Description of the Related Art

In general, an electronic component called a capacitor stores electricity in a physical mechanism without chemical reaction or phase change, and functions to collect and then send out the electricity to stabilize electric current within a circuit. This capacitor has a very short charging and discharging time, long lifespan, and very high output density, but is limited in the use as an energy storage device due to very small energy density thereof.

Whereas, a secondary battery can store high-density energy, and has been used as an energy storage medium for portable electronic applications, such as a notebook, a cellular phone, a PDA, and the like. A lithium ion battery is called as a byword for the secondary battery.

There is also an electrochemical capacitor, which expresses medium characteristics between the capacitor and the secondary battery and thus to be used as a storage medium of an electronic application requesting high energy density and high output density. The electrochemical capacitor is also called as a supercapacitor, an electrical double layer capacitor (EDLC), an ultracapacitor, and the like.

The electrochemical capacitor is potentially applicable as various fields of energy storage media, such as wind power generation, a hybrid electric vehicle (HEV), an electric vehicle (EV), and the like, and thus receives explosive interests over the world.

The most important core of the supercapacitor is an electrode material. The electrode material needs to have a high specific surface area above all, a large electric conductivity so that charges make the minimum voltage drop distribution at an electrode, electrochemical stability at a predetermined potential, and low price for commercialization.

These supercapacitors can be largely divided into three types of supercapacitors depending on the electrode and mechanism.

First, there is an electrical double layer capacitor (EDLC), which uses an activated carbon for an electrode and has a mechanism of electric double layer charging or electrostatic adsorption.

Second, there is a pseudocapacitor or a redox capacitor which uses transition metal oxide or conductive polymer as an electrode material and has a mechanism of pseudo-capacitance from chemically oxidation and reduction reaction.

Third, there is a hybrid capacitor having medium characteristics between the electric double layer capacitor and the redox capacitor.

In addition, the supercapacitor, particularly the EDLC, which is most commonly used currently, is operated by an electrochemical mechanism in which a voltage with several volts is applied to both ends of an electrode of a unit cell, and thus, ions within an electrolyte moves along electric fields and adsorbs a surface of the electrode.

Meanwhile, a basic structure of this supercapacitor consists of a porous electrode, an electrolyte, a current collector, and a separator.

The porous electrode may be formed by mixing an active material, a conductive material, a binder, a solvent, and other additives to prepare a slurry and coating the slurry on the current collector. Activated carbon is mainly used as the active material of the electrode while it has porosity in a surface thereof. Considering that specific capacitance is proportional to a specific surface area, the activated carbon increases energy density due to high capacitance of an electrode material.

Furthermore, while the active material slurry is coated and dried on the current collector, the binder is attached between the active material and the active material and between the active material and the current collector to form the electrode. The binder is one of the important factors in determining a performance of the capacitor. If the performance of the binder is dropped or an appropriate amount of binder is not contained within the electrode, it is difficult to form a film with uniform thickness at the time of coating the electrode. Furthermore, the active material becomes detached from the active material or the current collector, which decreases a capacitance of the capacitor or increases an inner resistance, even after the capacitor is constituted. Whereas, if the amount of the binder is excessively large, the amount of active material within the electrode is reduced, with the result that the capacitance of the capacitor is deteriorated, or the inner resistance is increased because of electric properties of polymer which is most electrical nonconductor.

Furthermore, a degree at which a specific surface area of an electrode of the electrical double layer capacitor actually contributes to express capacitance is 20 to 30%, which is less than half of the total capacitance. Therefore, when the active material and the conductive material are not well dispersed, the active material and the conductive material, individually, agglomerate together within the electrode. In this case, a dead volume becomes increased within an active material slurry so much, with the result that the capacitance is not expressed and impregnation with the electrolyte does not sufficiently take place on the entire surface of the electrode.

Therefore, for forming the electrode for the electrochemical capacitor, an appropriate content of binder, uniform dispersion of the active material and the conductive material, improvement of impregnation with the electrolyte, and the like are very important.

### SUMMARY OF THE INVENTION

An object of the present invention is to provide a composition for an electrode active material slurry having an improved dispersibility, thereby solving several problems occurring from the related art in respect to electrode composition in manufacturing an electrochemical capacitor.

Another object of the present invention is to provide an electrochemical capacitor including an electrode formed by applying the composition for an electrode active material slurry.

According to an exemplary embodiment of the present invention, there is provided a composition for an electrode active material slurry, including: an electrode active material; a material including a nonpolar hydrophobic functional group; and a surfactant.

The electrode active material may be activated carbon.

The nonpolar hydrophobic functional group may be a saturated alkyl group having 8 to 12 carbon atoms.

The surfactant may be a fluorine-based surfactant.

The fluorine-based surfactant may be a nonionic surfactant containing 80 to 95% of fluorine-based polymer component.

The material including a nonpolar hydrophobic functional group may bind to a surface of the electrode active material.

The material including a nonpolar hydrophobic functional group may be contained in 1 to 2 parts by weight based on 100 parts by weight of the electrode active material, and the surfactant may be contained in 0.01 to 5 wt % based on the total weight of the composition for an electrode active material.

The composition for an electrode active material slurry may include at least one selected from the group consisting of a conductive material, a binder, a solvent, and other additives.

As the solvent, water may be used to provide a water-based composition for an electrode active material slurry.

According to another exemplary embodiment of the present invention, there is provided an electrochemical capacitor, including: an electrode having a current collector coated with the composition for an electrode active material slurry including an electrode active material, a material including a nonpolar hydrophobic functional group, and a surfactant; a separator; and an organic electrolyte.

The electrode may be any one selected from a cathode and an anode

### DESCRIPTION OF THE PREFERRED EMBODIMENTS

Hereinafter, the present invention will be described in more detail.

Terms used in the present specification are for explaining the embodiments rather than limiting the present invention. Unless explicitly described to the contrary, a singular form includes a plural form in the present specification. Also, used herein, the word “comprise” and/or “comprising” will be understood to imply the inclusion of stated constituents, steps, operations and/or elements but not the exclusion of any other constituents, steps, operations and/or elements.

The present invention is directed to a composition for an electrode active material slurry and an electrochemical capacitor including an electrode having a current collector coated with the composition.

A composition for an electrode active material slurry according to the present invention may include an electrode active material, a material including a nonpolar hydrophobic functional group, and a surfactant.

As the electrode active material, activated carbon may be preferably used. As the activated carbon, any activated carbon that can be generally used in the field of supercapacitors may be used without the limitation to activation treatment methods and kinds of raw materials. Here, a specific surface area thereof is preferably 1500 to 3000 m²/g.

In addition, the composition for an electrode active material slurry of the present invention is to improve flowability thereof by using the surfactant. The composition for an electrode active material slurry according to the present invention is a water-based slurry composition using water as a solvent.

In the present invention, the surfactant is added to reduce surface tension of the active material and the conductive material, which have hydrophobicity in the water-based solvent, thereby increasing flowability of the composition for an electrode active material slurry. Therefore, a dead surface area of the composition for an electrode active material slurry is much decreased, resulting in increased capacitance of the electrochemical capacitor.

As the surfactant according to the present invention, any surfactant that can reduce surface tension of a carbon material in a water-based base may be used. A fluorine-based surfactant may be preferably used, but the surfactant according to the present invention is not limited thereto. As the fluorine-based surfactant, a nonionic surfactant containing 80 to 95% of fluorine-based polymer component may be preferably used.

The surfactant may be preferably contained in 0.01 to 5 wt %, of the entire composition for an electrode active material slurry. If the content of the surfactant is below 0.01 wt % of the entire composition for an electrode active material slurry, the surfactant is inadequate to improve the flowability of the electrode active material slurry. Whereas, if above 5 wt %, the surfactant affects viscosity of the electrode active material slurry, and thus badly affects stability in a coating process, and residues are most likely to remain at the time of a subsequent electrode dry process.

In addition, the composition for an electrode active material slurry according to the present invention preferably contains the material including a nonpolar hydrophobic functional group.

The material including a nonpolar hydrophobic functional group binds to a surface of the electrode active material, and thereby functions to improve wettability of the electrode in an organic electrolyte. In other words, when the material including a nonpolar hydrophobic functional group is added at the time of preparing the electrode active material slurry, the nonpolar hydrophobic functional group binds to the surface of the electrode active material. In addition, when the electrode, in which a current collector is coated with the electrode active material slurry, is impregnated with the organic electrolyte, the wettability of the electrode to the organic electrolyte can improved, which is advantageous in views of capacitance and resistance.

The nonpolar hydrophobic functional group is preferably a saturated alkyl group having 8 to 12 carbon atoms. A specific example of the material including this nonpolar hydrophobic functional group may be at least one selected from the group consisting of sodium oleate, potassium oleate, and an aqueous solution thereof, but is not limited thereto.

The material including the nonpolar hydrophobic functional group is preferably contained in 1 to 2 parts by weight based on 100 parts by weight of the electrode active material. If the content of the material including a nonpolar hydrophobic functional group is below 1 part by weight, wettability is unsatisfactorily improved in the electrolyte. Whereas, if above 2 parts by weight, the residual content of the material becomes large, thereby making it difficult to remove the residual materials.

Further, the composition for an electrode active material slurry according to the present invention may include at least one selected from the group consisting of a conductive material, a binder, a solvent, and other additives.

The conductive material may be at least one conductive carbon selected from the group consisting of acetylene black, carbon black, Super-P, and Ketjen Black, which are good conductive materials in graphite series, but is not limited thereto.

Further, water may be used as the solvent of the present invention, thereby providing a water-based composition for an electrode active material slurry.

Further, as the binder for attaching the electrode active material and the conductive material, carboxymethyl cellulose (CMC), styrene butadiene rubber (SBR), PVP, PTFE, and the like, may be used, but the kind of binder is not particularly limited.

In the present invention, the surfactant and a material including a nonpolar hydrophobic function group are added in the composition for an electrode active material slurry, thereby homogeneously mixing the activated carbon and the conductive material, which basically have hydrophobic tendency, with the result that a contact area between the electrode and the electrolyte can be maximized.

The case having this combination is more advantageous than a case where activated carbon and a conductive material are added in a water-based slurry into which a binder is added without the existing additives, in view of capacitance and resistance. In other words, when the active material and conductive material are added in the same amount, a contact area between the electrolyte and the electrode can be increased, thereby suppressing an increase in inner resistance due to shortage of the electrolyte.

Furthermore, the present invention can decrease the surface tension to water of the electrode active material and the conductive material, which have hydrophobicity, thereby increasing the flowability of the electrode active material slurry. Therefore, a dead surface area of the electrode active material is much decreased, and thus an increase in capacitance and a decrease in resistance can be anticipated.

In addition, the present invention can provide an electrochemical capacitor including an electrode including a current collector coated with the electrode active material slurry, a separator, and an organic electrolyte.

The electrode according to the present invention may be used as a cathode or an anode.

Furthermore, as the electrolyte of the present invention, an organic electrolyte using a polycarbonate-based solvent and the like are preferably used. Specific examples of solvent and electrolyte salt are particularly not limited, and any materials that can be generally used in the electrochemical capacitor may be used.

Furthermore, the electrochemical capacitor may be preferably applied for an electric double layer capacitor, but is not particularly limited thereto.

Also, the current collector, the separator, and the like constituting the electrochemical capacitor of the present invention are not particularly limited, and any materials that can be used in the electrochemical capacitor, such as a general electric double layer capacitor, may be used. A detailed description thereof will be omitted.

Hereinafter, examples of the present invention will be described in detail. The following examples are only for illustrating the present invention, and the scope of the present invention should not be construed as being limited by these examples. In addition, specific compounds are used in the following examples, but it is obvious to those skilled in the art that equivalents thereof can exhibit the same or similar degrees of effects.

### Example 1

### Preparation of Composition for Electrode Active Material Slurry

85 g of activated carbon (specific surface area: 2300 m²/g), 1.0 g of sodium oleate, 2.5 g of FC-4434 (3M fluorosurfactant) as a fluorine-based surfactant, 15 g of acetylene black as a conductive material, 3 g of CMC as a binder, 12.0 g of SBR, and 5.5 g of PTFE were mixed with 220 g of water, followed by mixing and stirring, thereby preparing an electrode active material slurry.

### Comparative Example 1

Activated carbon, acetylene black as a conductive material, and a binder, except for sodium oleate and surfactant, considering Example 1, were put into a water-based solvent, at the same weight ratio, followed by mixing and dispersing, thereby preparing an electrode active material slurry.

### Example 2

### Comparative Example 2

### Manufacture of Electrochemical Capacitor

1) Preparation of Electrode

The electrode active material slurry according to each of Example 1 and Comparative Example 1 was coated on an aluminum etching foil with a thickness of 20 μm using a comma coater, followed by temporary drying, and then cut into electrodes with a size of 50 mm×100 mm. The electrode has a cross-sectional thickness of 60 μm. The electrode was dried under vacuum at 120 for 48 hours, before assembling of a cell.

2) Preparation of Electrolyte

Spiro-based salt was dissolved in an acrylonitrile solvent to a concentration of 1.3 mol/L, thereby preparing an electrolyte.

3) Assembling of Capacitor Cell

A separator (TF4035 from NKK, cellulose-based separator) was inserted between the prepared electrodes (cathode and anode), followed by impregnation with the electrolyte, and then the resulting structure was put and sealed in a laminate film case.

### Experimental Example

### Evaluation on Capacitance of Electrochemical Capacitor Cell

Under the condition of constant temperature of 25, the cell was charged to 2.5V at a current density of 1 mA/cm² in a constant current-constant voltage mode, and then kept for 30 minutes. Then, the cell was discharged at a constant current of 1 mA/cm² three times, and then capacitance at the last cycle was measured. The results were tabulated in Table 1.

Resistance property of each cell was measured by an ampere-ohm meter and an impedance spectroscopy, and the results were tabulated in Table 1.

TABLE 1

| | Initial capacitance | Resistance |
|---|---|---|
| | (F) | (AC ESR, mΩ) |
| Com. Ex. 2 | 10.78 | 19.43 |
| Ex. 2 | 12.22 | 12.18 |

As seen from the results of Table 1, an electrochemical capacitor (EDLC cell) according to Comparative Example 2, which includes an electrode prepared by using the electrode active material slurry according to Comparative Example 1, which has a general composition of the electrode active material slurry, had capacitance of 10.78 F and resistance of 19.43 mΩ.

Whereas, an electrochemical capacitor (EDLC cell) according to Example 2, which includes an electrode prepared by using the electrode active material slurry according to Example 1, which contains the material including a nonpolar hydrophobic functional group and the surfactant, had capacitance of 12.22 F and resistance of 12.18 mΩ.

From these results, it can be seen that the surfactant was added to decrease surface tension to water of the active material and the conductive material, thereby preparing an electrode active material slurry having improved flowability.

Furthermore, when the electrode active material is used in the electrode of the electrochemical capacitor such as materials of an electric double layer capacitor, the nonpolar hydrophobic functional group included in the composition for the electrode active material slurry functions to improve wettability with the organic electrolyte, thereby increasing capacitance and effectively lowering electric resistance property.

According to the composition for an electrode active material slurry of the present invention, addition of a surfactant can improve flowability of a water-based composition for an active material slurry, thereby improving dispersibility of the composition.

According to the composition for an electrode active material slurry of the present invention, a material including the nonpolar hydrophobic functional group binds to a surface of an electrode active material, and thus, wettability to an organic electrolyte can be improved when an electrode having a current collector coated with the composition for an electrode active material slurry is impregnated with the organic electrolyte.

Therefore, an electrochemical capacitor including an electrode coated with this composition for an electrode active material slurry can have excellent capacitance and reduced resistance.

While the present invention has been shown and described in connection with the embodiments, it will be apparent to those skilled in the art that modifications and variations can be made without departing from the spirit and scope of the invention as defined by the appended claims.

What is claimed is:

1. A composition for an electrode active material slurry, comprising:
an electrode active material;
a material including a nonpolar hydrophobic functional group; and
a surfactant.

2. The composition for an electrode active material slurry according to claim 1, wherein the electrode active material is activated carbon.

3. The composition for an electrode active material slurry according to claim 1, wherein the nonpolar hydrophobic functional group is a saturated alkyl group having 8 to 12 carbon atoms.

4. The composition for an electrode active material slurry according to claim 1, wherein the surfactant is a fluorine-based surfactant.

5. The composition for an electrode active material slurry according to claim 4, wherein the fluorine-based surfactant is a nonionic surfactant containing 80 to 95% of fluorine-based polymer component.

6. The composition for an electrode active material slurry according to claim 1, wherein the material including a nonpolar hydrophobic functional group binds to a surface of the electrode active material.

7. The composition for an electrode active material slurry according to claim 1, wherein the material including a nonpolar hydrophobic functional group is contained in 1 to 2 parts by weight based on 100 parts by weight of the electrode active material, and the surfactant is contained in 0.01 to 5 wt % based on the total weight of the composition for an electrode active material.

8. The composition for an electrode active material slurry according to claim 1, wherein the composition for an electrode active material slurry includes at least one selected from the group consisting of a conductive material, a binder, a solvent, and other additives.

9. The composition for an electrode active material slurry according to claim 8, wherein the solvent is water.

10. An electrochemical capacitor, comprising:
an electrode having a current collector coated with the composition for an electrode active material slurry according to claim 1;
a separator; and
an organic electrolyte.

11. The electrochemical capacitor according to claim 10, wherein the electrode is any one selected from a cathode and an anode.
